(19) United States
(12) Patent Application Publication
(10) Pub. No.: US 2025/0307104 A1
(43) Pub. Date: Oct. 2, 2025

(54) METHOD TO TRACK AND VISUALIZE CONTRIBUTIONS TO COMPUTER PROGRAMS

(71) Applicant: International Business Machines Corporation, Armonk, NY (US)

(72) Inventors: Zhi Li, Beijing (CN); YE TIAN, Dalian (CN); Xiao Dong LI, Beijing (CN); He Jiang Jia, Beijing (CN); Sheng Jie Han, Beijing (CN); XING XING SHEN, Beijing (CN)

(21) Appl. No.: 18/618,042

(22) Filed: Mar. 27, 2024

(51) Int. Cl. G06F 11/32; G06F 8/73; G06F 11/30; G06F 11/36

(52) U.S. Cl. CPC G06F 11/323; G06F 8/73; G06F 11/302; G06F 11/3612; G06F 11/3636; G06F 2201/865

(57) ABSTRACT

According to one embodiment, a method, computer system, and computer program product for tracking contributions to computer programs is provided. The embodiment may include identifying a contribution to an application. The embodiment may also include tagging engrams in the application corresponding to the contribution. The embodiment may further include monitoring the application at runtime for a subset of the tagged engrams. The embodiment may also include preparing a visualization for one or more identified contributions based on an engram stored from the subset. The embodiment may further include presenting the visualization to a user.

### BACKGROUND

The present invention relates generally to the field of computing, and more particularly to source code management.

As software supply chains grow increasingly complex, tracking the provenance of software grows increasingly important. Teams often seek to track not only the external components used in a software project, but the individual contributors involved in writing, building, testing, designing, and translating the software. Keeping track of such contributions can facilitate efficient development (such as by asking a contributor about code for which they are responsible) and assist management of security risks, intellectual property risks, and a wide variety of other situations.

### SUMMARY

According to one embodiment, a method, computer system, and computer program product for tracking contributions to computer programs is provided. The embodiment may include identifying a contribution to an application. The embodiment may also include tagging engrams in the application corresponding to the contribution. The embodiment may further include monitoring the application at runtime for a subset of the tagged engrams. The embodiment may also include preparing a visualization for one or more identified contributions based on an engram stored from the subset. The embodiment may further include presenting the visualization to a user.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a process for tracking contributions according to at least one embodiment.

FIG. 3 illustrates an exemplary visualization created based on tracked contributions according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to source code management. The following described exemplary embodiments provide a system, method, and program product to, among other things, track contributions to a software project. Therefore, the present embodiment has the capacity to improve the technical field of communications by tagging a piece of software with engrams that can be used to efficiently track which contributions are currently being executed in the program.

As previously described, while software supply chains grow increasingly complex, tracking the provenance of software grows increasingly important. Teams often seek to track not only the external components used in a software project, but the individual contributors involved in writing, building, testing, designing, and translating the software. Keeping track of such contributions can facilitate efficient development (such as by asking a contributor about code for which they are responsible) and assist management of security risks, intellectual property risks, and a wide variety of other situations.

Software development can grow increasingly complex as the number of contributors increases. For many developers to coordinate, it is often crucial for them to understand who contributed each piece of the software, or when. As a particular example, fixing bugs may simpler if a debugging tool can connect an error to a relevant change and the contributor who made that change. As such, it may be advantageous to, among other things, use engrams to encode and track contributions as they relate to the live operation of a program.

According to one embodiment, a contribution tracking program identifies contributions in a software project. The contribution data may then be used to tag engrams representing the contributions into the program. The contribution tracking program may monitor these engrams at the program's runtime, storing them in an engram database. The contribution tracking program may then prepare a visualization of relevant contributions, and present that visualization to a user.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

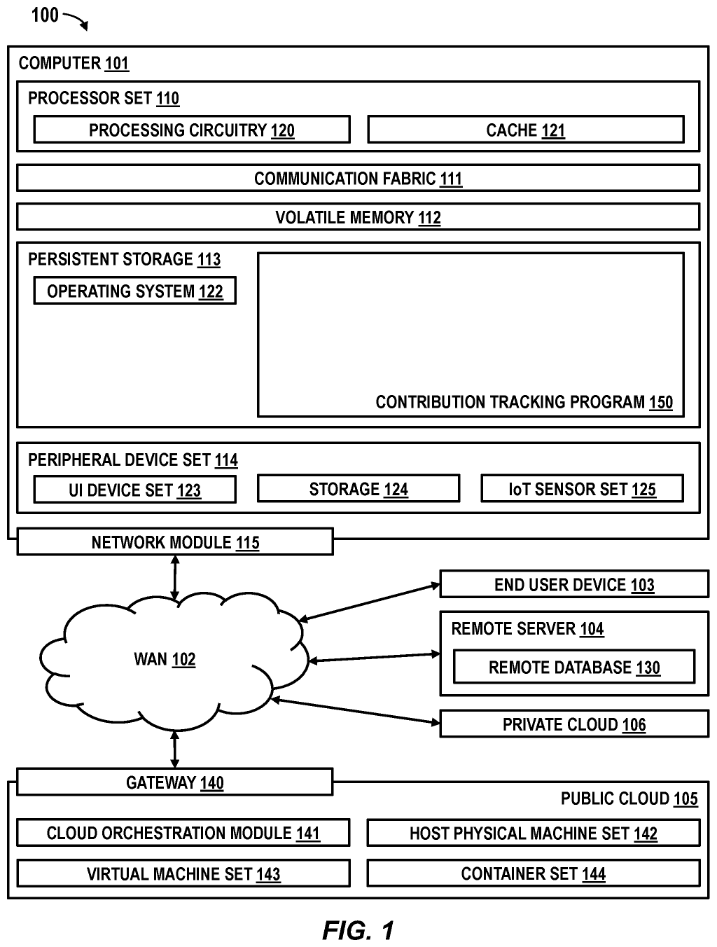

Referring now to FIG. 1, computing environment 100 contains an example of an environment for the execution of at least some of the computer code involved in performing the inventive methods, such as contribution tracking program 150. In addition to contribution tracking program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and contribution tracking program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in contribution tracking program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in contribution tracking program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth® (Bluetooth and all Bluetooth-based trademarks and logos are trademarks or registered trademarks of the Bluetooth Special Interest Group and/or its affiliates) connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The contribution tracking program 150 may identify one or more contributions to a software project. The contribution tracking program 150 may tag the software project with “engrams” corresponding to the contributions. An engram may be an encoding of the contributions used to help monitor software according to those contributions. The contribution tracking program 150 may monitor the project at runtime for engrams, storing them in an engram database. The contribution tracking program 150 may then present a visualization of contributions to users based on the engrams.

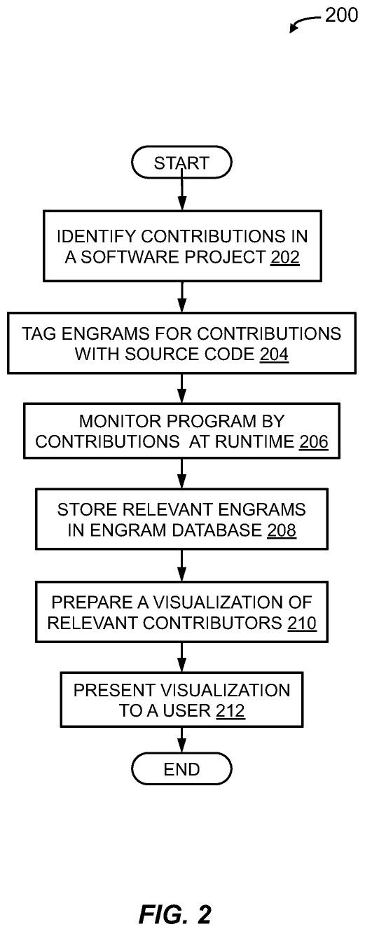

Furthermore, notwithstanding depiction in computer 101, contribution tracking program 150 may be stored in and/or executed by, individually or in any combination, end user device 103, remote server 104, public cloud 105, and private cloud 106. The data management method is explained in more detail below with respect to FIG. 2.

Referring now to FIG. 2, an operational flowchart for a process for tracking contributions to a software project 200 is depicted according to at least one embodiment. At 202, the contribution tracking program 150 identifies one or more contributions to a software project. A contribution may include a contribution to the source code of the software (a “developer contribution”), to the build process, to testing, to design, to documentation, to translation, or to any other part of the software development process. Identifying a contribution may include identifying any type of data about the contribution, about the contributor, or about any topic related to the program or the contribution. Any data collected about a contributor may be collected using opt-in procedures.

A contribution may alternatively be thought of as a set of changes submitted by a contributor, a “diff,” or a commit to a software repository. A developer contribution may also be thought of as a contribution to the source code of a computer program, as opposed to contributions to the build process, testing, documentation, or other aspects. Any contribution may be thought of as relating to the authorship of the software, either as they relate to copyright law or any other colloquial or abstract definition of authorship.

Identifying data may include priming the identified data into a form useful for tagging at 204. Once primed, data may be stored in a primed database. A database may be any database, file, directory, server, virtual server, or other store of data, and need not be on the same storage medium or media as any other feature of the contribution tracking program 150. Priming data may include taking only a subset of data that is relevant to the process for tracking contributions to a software project 200.

Identifying a contribution may include identifying, for example, a contribution identifier, which may be any unique datum for identifying a contribution; a type of the contribution, such as a development contribution or a translating contribution; the time of the contribution; an organization responsible for the contribution; information about a contributor, including a username, given name, family name, email address, employer, role, title, or type of contributor; a description of the contribution, as may be written by the contributor, an assistant, a maintainer, or an artificial intelligence capable of generating descriptions of contributions; or any other information about the contribution. A single contribution may involve one or more types of contribution, such as a contribution that includes both developer changes to the software itself and translation changes.

Identifying a contribution may further include, particularly in the case of development contributions, identifying a list of files changed, added, or removed; a list of lines changed, added, or removed in each file; a list of functions changed, added, or removed; the previous state of the changed portion; the current state of the changed portion; the programming language in which the contribution was written, or any other information pertaining to the development or other changes.

Identifying a contribution may further include, particularly in the case of build contributions, identifying a source file, directory, or path; a built file, directory, or path; a time that a build was started or completed; how long a build took; or a record of any build errors. In the case of test contributions, identifying may further include such features as an issue identifier, issue description, issue date, or test result.

Identifying a design contribution may include identifying a list of files that were changed, added, or removed, or any other information parallel to developer information, particularly in the case of changes to markup text or style sheets. Design contributions may also include, for example, changes to image files, animations, audiovisual assets, or any other design assets, and may be tracked through any system for editing or managing those assets.

Identifying documentation contributions may include, for example, identifying files and lines that were added, changed, or removed, as well as any design changes to the documentation, such as a modification to a video embedded in a contribution PDF. Identifying translation contributions may include translation information such as which lines were translated, which lines were changed in a particular translation, the original language text is being translated from, the language text is being translated into, or a primary language of the translator.

Contributions and edits may be tracked directly by the contribution tracking program 150, or through other tools, such as a source code management system, integrated development environments, text editors, built tools, testing tools, design tools, word processors, translation tools, documentation management tools, or any combination of these.

The contribution tracking program 150 may identify changes to a contributor over time. For example, if a contributor changes their given name, but maintains a standard username, the contribution tracking program 150 may start using the user's new given name for future contributions or may modify the user's given name in the primed data to consistently identify the user by the new given name. As another example, if the contribution tracking program 150 identifies the age of each contributor, it may do so by tracking the date of birth of the contributor, the age of the contributor at the time of contribution, the age of the contributor at present, or all of the above.

The contribution tracking program 150 may further identify features of the software project, such as a size, an overall owner (such as a corporation responsible for developing the software), a license or a contributor agreement (as may be the case for an open source project), or an interconnected file structure, for example through tracking function calls, or through analyzing a directory structure.

A software project may be a proprietary software project or a Free Software or open-source software project. A software project may be commercial or noncommercial in nature and may be developed or maintained in a public or private manner. Contributors may include paid contributors, hobbyists, students, or any other individuals who may contribute for any reason. A software project may be developed in a compiled language, a scripting language, or any other language, particularly so long as there is a source code form (or any form users may contribute to, including user-written machine code) and an executable form (including both compiled programs and source code forms of software written in scripting languages, which may be executed as is). The software project may correspond to a piece of software or a program; these terms may be used interchangeably to refer to the same project in source form, object form, or both.

A software project may include any program or application, including a web application or a video game. In alternate embodiments, the contribution tracking program 150 may identify contributions to a non-software project, such as a pure documentation project, a shared video work, or a joint graphical design work. The contribution tracking program 150 may identify contributions to more than one work, such as contributions to a suite of software projects, and documentation for those projects.

Then, at 204, the contribution tracking program 150 tags engrams representing contributions in the software. An engram may be an encoding of or representation of a contribution or a contributor that may be useful in the tagging process. Engrams may be tagged into source code, object code, or both. Engrams may be invisible to an end user, seen only by the functions that require access to the engrams.

The tagging may be performed using a “tagging module,” in conjunction with a source code management system, through any database, or using a compiler, optimizer, or similar code processor. Engrams may correspond to any data identified at 202, including, particularly, primed data.

An engram may be an encoding of or representation of a contribution or a contributor that may be useful in the tagging process, and may be derived from a contribution, either anonymously or as associated with a user.

Engrams may be tagged into source code, object code, or both. For example, engrams may be added to source code files directly, or in source code directories alongside files. Alternatively, engrams may be tagged in a tagged database, which may include associations with the source code repository, and the portions of source code tagged. The contribution tracking program 150 may then associate the relevant portions of executable code, such as by integration with a compiler or similar code processor, or any other process of association.

In a further embodiment, engrams may be generated as source code in a form that encodes the relevant contribution information in order to make the contribution information accessible at runtime, as may then be understood by an event handler, monitoring module, debug module, error handling function, or similar portion of software, either separate from or integrated into the contribution tracking program 150. Engrams may be encoded as functions, events in an event-handler system, or in any other way that may affect their purpose.

An engram may minimize, compress, encrypt, or reference identified data, or utilize any other technology for efficient storage or processing of data. For example, an engram may merely include a pointer or reference to a storage location of data in a primed database. Alternatively, an engram may include only a subset of data that is important in identifying the data or in presenting the visualization.

Then, at 206, the contribution tracking program 150 monitors the software at runtime, identifying engrams related to the code being executed. Monitoring may include monitoring machine code or other executable code, monitoring tagged engrams, or monitoring the associations between engrams, executable code, and source code.

In a preferred embodiment, monitoring may include monitoring machine code for associations among the tagged engrams. Once identified while running, an engram may be stored at 208, or may be used to associate a portion of object code currently in execution to a tagged portion of source code related to the engram.

Monitoring may be performed using an event handling or error handling system, a dedicated monitoring module, or by following any tag or association relating to an engram tagged at 204.

Then, at 208, the contribution tracking program 150 stores the relevant engrams in an engram database. The relevant engrams may be all engrams found during monitoring at 206, engrams relevant to a particular section or module of code, engrams relevant to a particular bug or support request, engrams that coincide with an error, or any other selection of engrams deemed relevant by the contribution tracking program 150. Storing engrams may include storing a reference to the engram, the engram itself, contribution data corresponding to the engram, or any additional data relating to the engram or contribution data. Storing may be performed by a storing module or the monitoring module or by any other portion of the contribution tracking program 150.

An engram database may be any database, file, directory, server, virtual server, or other store of data, and need not be on the same storage medium or media as any other feature of the contribution tracking program 150.

Storing engrams may include storing a reference to the engram, the engram itself, contribution data corresponding to the engram in an engram database. In further embodiments, storing engrams may include storing any additional data relating to the engram or contribution data. For example, storing an engram may include storing information about an error that coincided with the monitoring of the engram. As another example, storing additional data may include identifying and storing new data about a contributor that was not previously identified.

Monitoring and storing engrams at 206 and 208 may happen in sequence, in parallel, simultaneously, continuously, in an alternating pattern, or in any other manner as may be useful to the process for tracking contributions to a software project 200.

Then, at 210, the contribution tracking program 150 prepares a visualization of contributions based on the stored engrams, or any other data stored at 208 stored in connection with the engrams. A visualization may come in any form but may particularly be useful in a form that effectively displays content and contributions relevant to those contributions. Preparing a visualization may include generating or modifying a layout, generating or modifying assets, placing assets in a layout, or doing anything else to create or modify the visualization to the point where it displays relevant data. Preparing a visualization may include analyzing the engrams or engram-associated data to identify or generate data to display in the visualization.

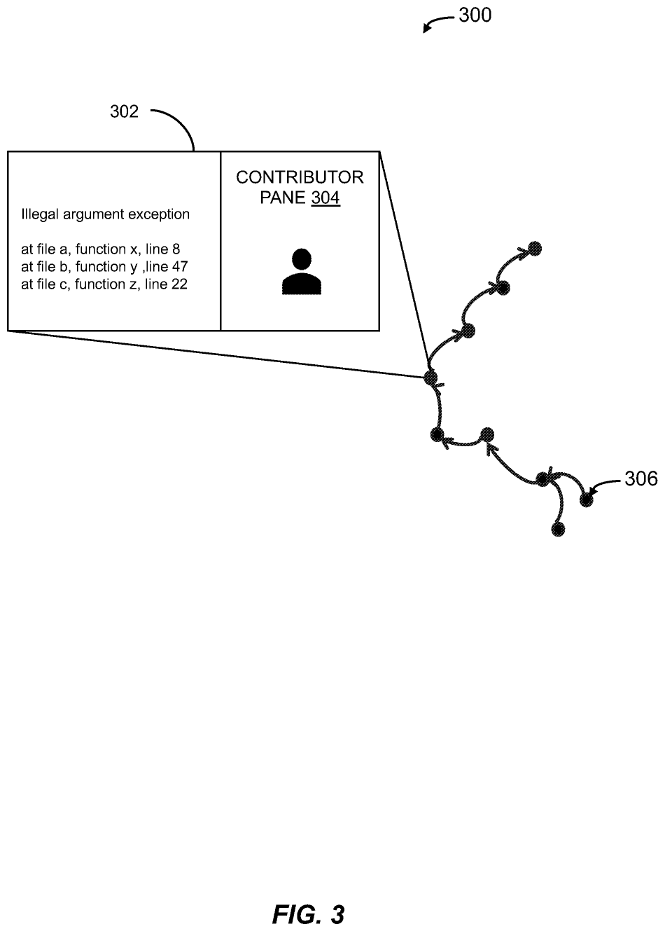

A visualization may come in any form but may particularly be useful in a form that effectively displays content and contributions relevant to those contributions. A visualization may include text content, images, charts, graphs, trees, video content, interactive features, animations, or any other elements of a visualized layout, graphic, or document that may be used to present relevant data. An exemplary visualization is provided at FIG. 3, including a debug pane 302, a contribution pane 304, and a contribution tree 306.

Preparing a visualization may include analyzing the engrams or engram-associated data to identify or generate data to display in the visualization. Software that prepares a visualization may be called an “analyzing module.” Analyzing may include using engram data to access data identified at 202 or identify new data; filtering any data so that only relevant data is included in the visualization; processing data, such as by calculating an average, calculating an age of a contribution based on the present time when the visualization is prepared and the time of the contribution, or creating a chart from the data; processing metadata, such as by determining names and scales for axes on a chart based on variable names and a range of known values for the variable represented in that axis; translating data into a new language or format; or any other processing, transforming, or analyzing of data.

Preparing a visualization may include generating or modifying a layout, generating or modifying assets, placing assets in a layout, or doing anything else to create or modify the visualization to the point where it displays relevant data. For example, preparing a web-based visualization may include generating image assets using a chart generation tool, prepare a layout by modifying a preexisting markup document such as an HTML document with CSS styling and JavaScript elements affecting the layout, color, font size, and other details, and placing the generated image assets within the layout. Alternatively, an existing user interface for a stack trace and error handling system may add a pane for contribution information, a hidden contribution tree 306, and a button to expand and view the hidden contribution tree 306. As yet another alternative, preparing a visualization may include placing a series of generated charts and graphs into a PDF document alongside a text generated by a generative AI to explain relevant contribution information.

In a further embodiment, a visualization may include a visualization of contributions or of contributors in a tree format. For example, a contribution tree 306 may include a node for each contribution and a tree structure pointing from prior contributions to later contributions in a series of contributions. In further examples, a contribution tree 306 may include nodes of different sizes, colors, or shapes, representing, for example, a type of contribution, a size of the contribution, a role of a contribution, or any other information about the contribution or contributor. Further, still, a tree may be interactive; selecting a node on the tree may show information about the selected contribution and may highlight selected node.

Preparing may include modifying an existing visualization The contribution tracking program 150 may prepare any number of visualizations, and may prepare and modify representation at any time, including at a regular interval, in response to a user interaction such as those described at 212, in response to storing an engram at 208, in response to monitoring at 206, in response to an error, event, or similar trigger, or at any other time or combination of times.

Then, at 212, the contribution tracking program 150 presents the visualization to a user. Presenting may include displaying, notifying, messaging, or otherwise providing the user with access to a visualization. The visualization may be presented through a dedicated user interface, or as part of an existing user interface such as a debug menu or code management system. The visualization may be presented in response to a user request, in response to an event, or at any other time.

Presenting may include displaying, notifying, messaging, or otherwise providing the user with access to a visualization. For example, presenting a PDF-based visualization may include sending a user an email with the PDF file attached, or sending a user a link to a web-based platform that the user can visit to access the visualization. Alternatively, presenting a visualization may include adding a button or other interactive element to an existing layout, such as a debug menu, that will display the visualization most relevant to the context in the debug menu.

The visualization may be presented through a dedicated user interface, or as part of an existing user interface such as a debug menu or code management system. The visualization may be presented in response to a user request, in response to an event, or at any other time.

In alternate embodiments, the visualization, once prepared, may be provided to a user through any other medium, such as placement in a prepared slideshow or video, or printing on paper.

Referring now to FIG. 3, an exemplary visualization created based on tracked contributions 300 is depicted according to at least one embodiment. The visualization may include a debug pane 302, a contribution pane 304, and a contribution tree 306.

In at least one embodiment, the visualization may include charts or figures such as contribution tree 306. Contribution tree 306 may consist of a node for each contribution or contributor and a tree structure pointing from prior contributions to later contributions in a series of contributions. A contribution tree 306 may include nodes that are visually distinct from one another to signify different information, including nodes of different sizes, colors, or shapes, representing, for example, a type of contribution, a size of the contribution, a role of a contribution, or any other information about the contribution or contributor. Selecting a node in contribution tree 306 may modify views of debug pane 302 or contributor pane 304. For example, if a user selects a large triangular yellow node corresponding to a large development contribution, the contribution pane 304 may display information about that contribution and the contributor who made it, and the debug pane 302 may highlight items in a stack trace that correspond to that contribution. A currently selected node may be highlighted or outlined in any color. In alternate embodiments, the node may display with a profile photo identifying the contributor responsible for the contribution represented by the node.

In at least one embodiment, debug pane 302, may include a stack trace or similar framing of the state of a program's operation, or of an error, displaying file names, lines of code, function names, error codes, or other similar information. Debug pane 302 may include or be paired next to contribution pane 304. Selecting a particular line or item in debug pane 302 may highlight a particular node in contribution tree 306 that corresponds to the most recent change to that line item, or to all changes that correspond to the line item, and display information in contribution pane 304 corresponding to one of the highlighted nodes.

In at least one embodiment, contributor pane 304 may display information about a contribution or a contributor, such as the date and time of a contribution, the username of the contributor responsible for the contribution, a profile photo of the contributor, and a button to contact the contributor.

In alternate embodiments, the visualization may include other elements, including text elements, images, videos, charts, graphs, interactive elements, and anything else described at 210. A visualization may include any combination of these elements as may be useful to users of the contribution tracking program 150.

It may be appreciated that FIGS. 2 and 3 each provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
identifying a contribution to an application;
tagging engrams in the application corresponding to the contribution;
monitoring the application at runtime for a subset of the tagged engrams;
preparing a visualization for one or more identified contributions based on an engram stored from the subset; and
presenting the visualization to a user.

2. The method of claim 1, wherein the visualization includes a contribution tree.

3. The method of claim 2, wherein the contribution tree includes two or more nodes that are visually distinct from one another.

4. The method of claim 1, wherein identifying the contribution further includes identifying a type of the contribution.

5. The method of claim 4, wherein the types of contribution include at least development contribution, build contribution, and test contribution.

6. The method of claim 1, wherein tagging an engram includes placing the engram in the source code of the program.

7. The method of claim 1, wherein the visualization includes a stack trace.

8. A computer system, the computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
identifying a contribution to an application;
tagging engrams in the application corresponding to the contribution;
monitoring the application at runtime for a subset of the tagged engrams;
preparing a visualization for one or more identified contributions based on an engram stored from the subset; and
presenting the visualization to a user.

9. The computer system of claim 8, wherein the visualization includes a contribution tree.

10. The computer system of claim 9, wherein the contribution tree includes two or more nodes that are visually distinct from one another.

11. The computer system of claim 8, wherein identifying the contribution further includes identifying a type of the contribution.

12. The computer system of claim 11, wherein the types of contribution include at least development contribution, build contribution, and test contribution.

13. The computer system of claim 8, wherein tagging an engram includes placing the engram in the source code of the program.

14. The computer system of claim 8, wherein the visualization includes a stack trace.

15. A computer program product, the computer program product comprising:
one or more computer-readable tangible storage media and program instructions stored on at least one of the one or more tangible storage media, the program instructions executable by a processor capable of performing a method, the method comprising:
identifying a contribution to an application;
tagging engrams in the application corresponding to the contribution;
monitoring the application at runtime for a subset of the tagged engrams;
preparing a visualization for one or more identified contributions based on an engram stored from the subset; and
presenting the visualization to a user.

16. The computer program product of claim 15, wherein the visualization includes a contribution tree.

17. The computer program product of claim 16, wherein the contribution tree includes two or more nodes that are visually distinct from one another.

18. The computer program product of claim 15, wherein identifying the contribution further includes identifying a type of the contribution.

19. The computer program product of claim 18, wherein the types of contribution include at least development contribution, build contribution, and test contribution.

20. The computer program product of claim 15, wherein tagging an engram includes placing the engram in the source code of the program.
